(19) United States
(12) Patent Application Publication
(10) Pub. No.: US 2002/0183970 A1
(43) Pub. Date: Dec. 5, 2002

(54) Computer assisted method and system for accurately predicting CO2 shelf-life of polyester containers for carbonated beverages

(75) Inventor: Mark Rule, Atlanta, GA (US)

Correspondence Address: FINNEGAN, HENDERSON, FARABOW, GARRETT &, DUNNER LLP, 1300 I STREET, NW, WASHINGTON, DC, 20005, US

(73) Assignee: The Coca-Cola Company

(21) Appl. No.: 09/817,140

(22) Filed: Mar. 27, 2001

(51) Int. Cl. G06F 15/00

(52) U.S. Cl. 702/181

(57) ABSTRACT

A computer assisted method and system for accurately predicting CO₂ shelf-life of polyester containers for carbonated beverages utilizes computer models, which take in to account all relevant physical and chemical parameters. The computer models permit a container designer to readily and accurately predict CO₂ shelf-life.

### BACKGROUND OF THE INVENTION

1. Field of the Invention

The present invention relates to a process analyzing phenomena that affect shelf-life of polyester containers with respect to carbonation. More specifically, the present invention relates to development of mathematical models for the accurate prediction of CO₂ shelf-life through a computer assisted process, and utilization of those models to optimize shelf-life of carbonated beverage containers.

2. Background of Related Art

Shelf-life can be broadly defined as the length of time between the initial packaging of a product, and the point at which consumers notice a decrease in product quality. Thus, the shelf-life of a product is determined by the least stable aspect of that product or its package. For many beverages in plastic packaging, the factor that determines shelf-life is carbonation retention.

Plastics have a number of advantages over more traditional packaging materials, such as glass and metal. Plastics are strong, lightweight, corrosion resistant, shatter-resistant, and easily processed into a variety of shapes. However, plastics are not a panacea. Unlike metal and glass, all plastics are to some extent permeable to gases and vapors. Consequently, selection of the appropriate plastic for packaging each product requires more care, and greater attention must be paid to the impact of permeation (into, out of, and through the plastic) on the quality of the product. Moreover, optimizing the shelf-life of a product packaged in a selected plastic requires an in-depth understanding of the physics and chemistry of the processes that affect that shelf-life.

Although hundreds of thousands of plastics have been identified, only a few hundred distinctly different ones have been commercialized. Of these, very few possess the barrier, clarity, processability, and mechanical strength appropriate for use in carbonated beverage containers. With the additional constraints of cost and regulatory/environmental issues, there is essentially only one plastic material in wide-spread use today, especially for the non-returnable container market. That material is the polyester poly(ethylene terephthalate) (PET), in all of its various modifications.

Accordingly, there is a need in the art for a process and system for analyzing parameters of physics and chemistry of carbonated beverages in plastic containers which significantly affect CO₂ shelf-life, and distinguishing those parameters from other parameters which do not affect shelf-life, in order to develop readily useable computer models for determining shelf-life.

### SUMMARY OF THE INVENTION

Accordingly, a primary aspect of the present invention is to develop a process which selectively distinguishes between phenomena which clearly affect shelf-life from parameters that do not, and developing mathematical models for calculating shelf-life for a variety of types of plastic beverage containers and related conditions.

The mathematical models are effectively utilized by providing a computer assisted method for accurately predicting CO₂ shelf-life of plastic containers for carbonated beverages comprising the steps of:

a) establishing a maximum loss value of CO₂ gas from the container at which the carbonated beverage will still be of acceptable quality;

b) selecting the size of plastic container to be designed including,

1) a brimful capacity of the container,

2) a total surface area of the container; and

3) thickness of container sidewalls;

c) selecting a type of closure to be secured on the plastic container;

d) selecting the dimensions of a finish portion of the container to which the closure is secured;

e) selecting a type of plastic material from which the container is to be fabricated;

f) selecting an initial pressure of the carbonated beverage to be stored in the container;

g) selecting a loss rate of the pressure in the container at a predetermined temperature; and

h) calculating shelf-life with the computer using data representative of each of the selections made in steps a) to g), or other selected sub-groups of those steps.

In accordance with aspects of the present invention, software related to the foregoing method and mathematical models are recorded on a computer readable medium such as floppy disc, hard-drive or CD-ROM.

In a further aspect, the software is embodied in a data signal propagated in a carrier wave, which is transmittable between networked computers to multiple users.

A computer system for practicing the invention, comprising one or more data input terminals, each terminal including: a data input device; a monitor with a display screen; and an operating system for providing data input display fields in a window on the display screen, said display fields in combination with said data input device comprising said means for selectively inputting parameters which affect shelf-life into the computer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWINGS

The present invention will become more fully understood from the detailed description given hereinbelow and the accompanying drawings which are given by way of illustration only, and thus are not limitative of the present invention, and wherein:

FIG. 1 is a graph showing the effect of stress on permeability of polyesters;

FIG. 2 is a graph showing the effect of temperature on permeability of CO₂ gas through polyesters;

FIG. 3 is a graph illustrating the behavior on shelf-life of CO₂ gas vs. carbonated beverage filled containers;

FIG. 4 is a graph illustrating the effect of crystallinity on permeability of polyesters;

FIG. 5 is a graph depicting the effect of time on volume expansion of a polyester container;

FIG. 6 is a graph illustrating the effect of time on CO₂ pressure loss in polyester containers;

FIG. 7 depicts a display screen on a computer monitor of one embodiment of a CO₂ shelf-life model as a window of display fields for input and output of information associated with the use of that model;

FIG. 8 depicts a display screen of a second model according to the present invention;

FIG. 9 depicts a display screen of a third model according to the present invention;

FIG. 10 depicts a display screen of a fourth model according to the present invention;

FIG. 11 depicts a display screen of a preferred model for a PET bottle; and

FIGS. 12a and 12b are graphs depicting the impact of both temperature and initial fill pressure on time to reach 3.3 volumes of CO₂.

### DETAILED DESCRIPTION OF PREFERRED EMBODIMENTS

Factors that Affect CO₂ Shelf-Life

Ultimately, there are two separate phenomena that cause a loss of carbonation pressure in polyester containers: permeation and volume expansion. Each of these phenomena, in turn, is affected by a number of factors, many which are common to both. Since permeation is the greater contributor to loss of pressure, one should begin first with what permeation is, how permeation affects the pressure within a container, and the factors that affect permeation.

Permeation

Permeation is the process where molecules migrate through a solid material. Permeability is the inherent rate that these molecules migrate through a plastic under defined conditions. Factors that affect permeability of polyesters are: temperature; stress; polymer composition; crystallinity; and orientation.

Temperature has a large effect on the permeability of CO₂ in polyesters. First, permeation is a temperature dependent phenomenon, and in polyesters such as PET, every degree C. increase in temperature will result in about a 3.8% increase in the permeation rate, if there is no change in the stress on the polyester.

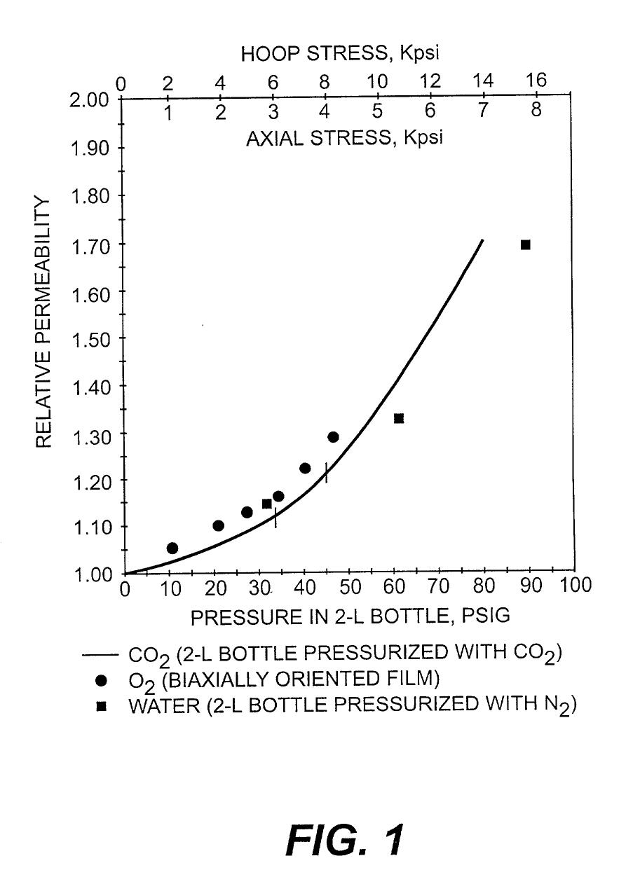

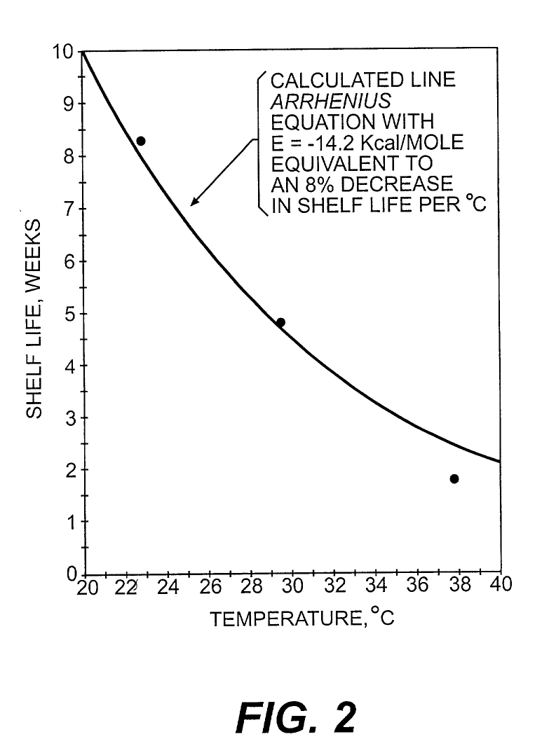

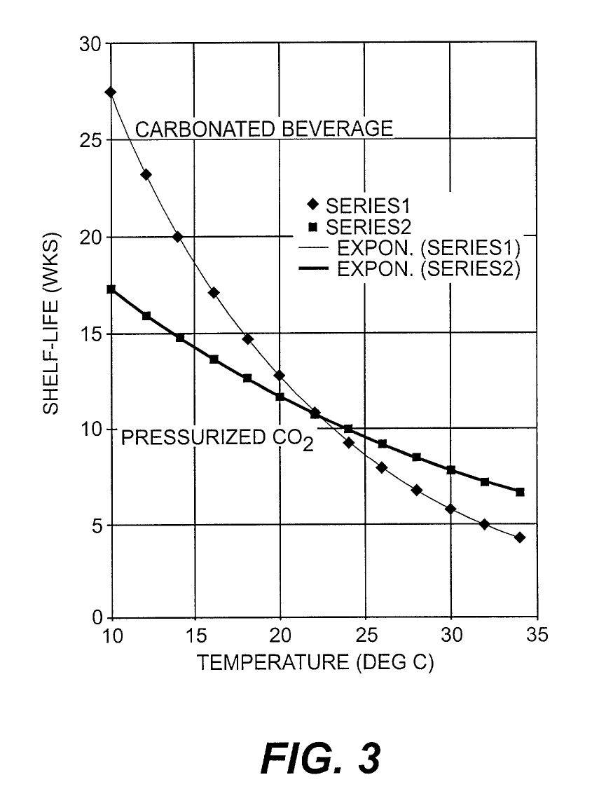

Stress also has an effect on the permeability of polyesters. Stress occurs whenever a polymer film (or container sidewall) is held in tension, and has the net effect of slightly increasing the distance between polymer chains, making it easier for gas molecules to move through the solid. In polyester containers, the permeability increases with the square of the internal pressure (see FIG. 1). In addition, since pressure increases with increasing temperature in a closed container, a polyester container filled with CO₂ gas will exhibit about a 4% increase in permeability per degree C. This is a result of the combination of both the increase in stress and the increase in the fundamental permeability. When a polyester container is filled with a carbonated beverage, the increase in pressure (and hence the increase in stress) is much greater than if the container were filled just with CO₂ gas. This is because the solubility of the CO₂ gas in the beverage decreases with increasing temperature, forcing more of the gas out of the liquid. The net effect is that, with carbonated beverage, the increase in permeability is 8% per degree C. (see FIG. 2). The impact of this behavior on shelf-life of CO₂ gas filled vs. carbonated beverage filled polyester containers can be seen in FIG. 3. (Coincidentally, the cross-over point is at 22 deg. C.) Polymer Composition can have a significant impact on permeability. The effect of comonomers on the permeability of a polyester can be readily calculated, if the permeability of respective homopolymers is known. Thus, there is about a 7% difference in permeability between a polyester made with 1.5 mole % CHDM modifier and a polyester made with 2.0 mole % IPA modifier, since poly(ethylene isophthalate) has about 4× better barrier than PET homopolymer, while poly(cyclohexylenedimethylene terephthalate) has about 4.2× worse barrier than PET homopolymer. What is important is the bulk composition, rather than the degree of randomness, and a blend will have the same barrier properties as a random copolymer of the same bulk composition (assuming that they both possess the same level of crystallinity).

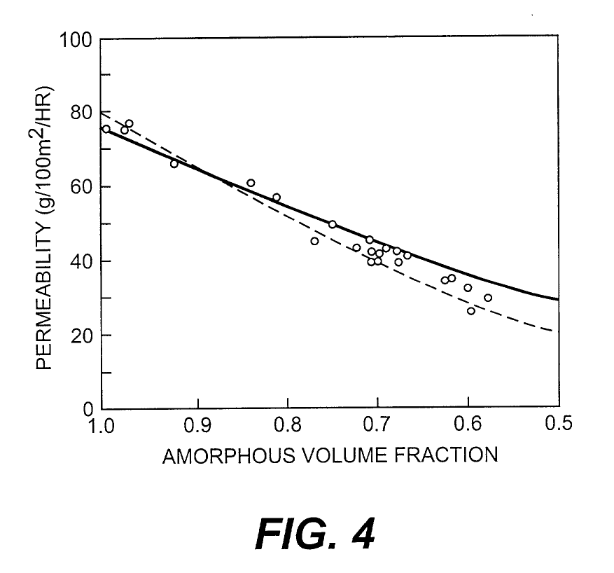

Crystallinity has a dramatic impact on the permeability of any polymer, and polyesters are no exception (see FIG. 4). In general, the permeability of PET will be proportional to the square of the volume fraction of amorphous material; therefore, a PET that is 40% crystalline will have 36% of the permeability of amorphous PET.

Orientation can also make a contribution to the barrier of PET, although its impact is not nearly as important as crystallinity. Estimates of the relative impact of crystallinity vs. orientation have ascribed about 80% of the barrier enhancement observed in oriented PET to crystallinity, and the remaining 20% to orientation.

Factors that do not significantly affect the permeability of polyesters are: molecular weight; blow molding conditions; areal stretch ratio; heatsetting; and moisture.

Volume Expansion

When a polyester container is pressurized, it will expand under the stress of that pressure. As discussed in the preceding text, stress impacts the permeability of a polymer. An additional effect of stress is to increase the volume of the container. Since the amount of gas in the container is fixed, an increase in volume will result in a concomitant decrease in the pressure inside of the container. Because shelf-life is concerned with the total pressure in the container, and not just the amount of CO₂ gas, one also needs to be concerned with the impact of volume expansion on shelf-life.

Volume expansion can be divided into two components: initial volume expansion, and creep. The initial volume expansion a container will undergo can be calculated from the gauge pressure, the total volume, surface area, tensile Modulus, and sidewall thickness (Equation 1).

$$Volume Expansion = \frac{{( 1 + pressure * volume )}^{3}}{{( Surface area * tensile Modulus * thickness )}^{3}} - 1 \qquad ( 1 )$$

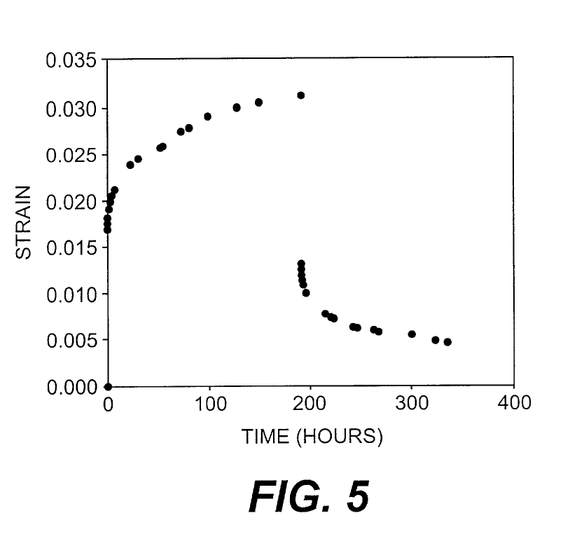

Creep is a much more difficult quantity to calculate, primarily because models that accurately predict creep over time have not yet been developed. However, for polyester containers, empirical observations indicate that the volume expansion due to creep is almost exactly the same as the initial volume expansion (see FIG. 5), and occurs at an ever-decreasing rate over the first 200 hours after initial pressurization. Therefore, by using this empirical observation and measuring the creep over time for polyester, the total volume expansion over time for any polyester container can be estimated.

Impact of Package Design and Processing

Having reviewed the factors that affect the fundamental permeability and volume expansion of polyesters, one can now address how these parameters interact with package design to determine shelf-life. To do this, one must review how permeability and volume expansion are related to pressure loss.

The units of permeation are

$$P = \frac{mass \times thickness}{conc . \times time \times surface area} \qquad ( 2 )$$

Since the units for loss of CO₂ through a container wall is mass (usually expressed as cubic centimeters at standard temperature and pressure), the amount of gas lost in any specified time interval will be:

$$Loss of {CO}_{2} = \frac{P \times conc . \times time \times surface area}{thickness} \qquad ( 3 )$$

Where conc. is the concentration of CO₂ inside the container, surface area is the total surface area of the container, and thickness is the thickness of the sidewall of the container. Now, it is unusual for a plastic container to have a single wall thickness, or, for that matter, to be made of a single material (if the closure is considered); however, Equation (3) is still applicable, if one considers instead the CO₂ loss through every subsection of the container, and then sums all of the sources of CO₂. (It is important to note that the surface area referenced above is the total surface area of the package, not just the surface area above the liquid level. Dissolved CO₂ is still available for permeation.)

To determine the impact of the loss of this amount of CO₂ on the pressure inside the container, equation (4) can be applied:

$$\begin{matrix}Pressure Loss = \frac{Loss of {CO}_{2}}{Total Volume of container} & ( 4 ) \\ Combining equations ( 3 ) and ( 4 ) , results in , \\ Pressure Loss = \frac{P \times conc . \times time \times surface area}{Volume \& thickness} & ( 5 )\end{matrix}$$

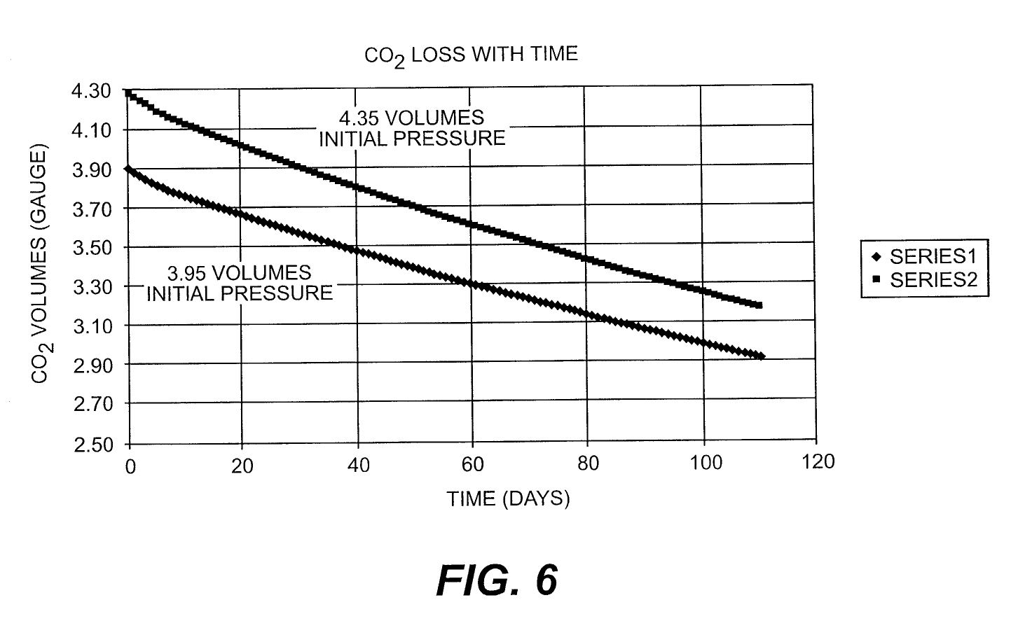

Thus, the factors that affect the CO₂ pressure loss in a container are the permeability (P), the CO₂ concentration, the time, the surface area, the volume of the container, and the thickness(es) of the container sidewall. It should be noted that as the pressure decreases, the concentration of CO₂ decreases; therefore the rate of pressure loss is not constant per unit time, but is continually decreasing (see FIG. 6). (In addition, the volume of the package is not constant, but increases slightly due to volume expansion over the first 200 hours or so after filling.

Because of the continually changing pressure due to permeation and volume expansion, the shelf-life models constructed in accordance with the present invention calculate the amount of CO₂ lost in a small increment of time (usually 1 day), and then adjusts the value for pressure based on the CO₂ lost and the volume expansion. By carrying out these steps in one-day increments, the changes in the permeability factor due to the stress factor and temperature are accounted for. The models of the present invention also have built in the procedure used to measure shelf-life; thus, since the initial data point (zero percent loss) is taken 30 minutes after filling, the model sets the initial pressure as the pressure after 30 minutes of volume expansion and permeation has occurred.

Inspection of equation (5) reveals that pressure loss is linear with surface area; therefore, increasing surface area (holding all other variable constant) will result in an increase in the rate of pressure loss. Conversely, increasing the volume or the sidewall thickness will decrease the rate of pressure loss (at a fixed surface area). Also, because the thickness is in the denominator, a proper measure of the effective sidewall thickness of a package is not the average thickness, but rather is

$$1 / t h i c k n e s s = \frac{1}{n} \times {{•}_{i = 1}^{n} ( 1 / t h i c k n e s s )}_{i} \qquad ( 6 )$$

Comparison of this equation with the results from simple averaging of sidewall thicknesses shows that equation (6) will always yield a lower effective sidewall thickness whenever there is any variability in sidewall thickness, and is equal to the average thickness only when the bottle sidewall is completely uniform. Since the mass of material in a bottle sidewall is proportional to the average thickness, and the barrier properties of oriented PET are ˜2× that of unoriented PET, it follows that the most effective use of the polyester will occur when the entire bottle (base, sidewall, neck, etc.) is oriented and the material distribution is completely uniform. Similarly, inspect of equation (1) reveals that the volume expansion a container will undergo, will decrease with increasing sidewall thickness, and since sidewall thickness also appears in the denominator of equation (1), a more uniform sidewall thickness will also result in a lower volume expansion.

One aspect that has not been discussed in the foregoing is the impact of the closure. Because of the much higher permeability of polypropylene over PET, plastic closures can make a significant contribution to CO₂ loss, especially in smaller packages where the loss through the closure can exceed 10-15% of the total loss. The CO₂ models of the present invention discussed hereinafter have incorporated in them the CO₂ loss performance for a number of different closures.

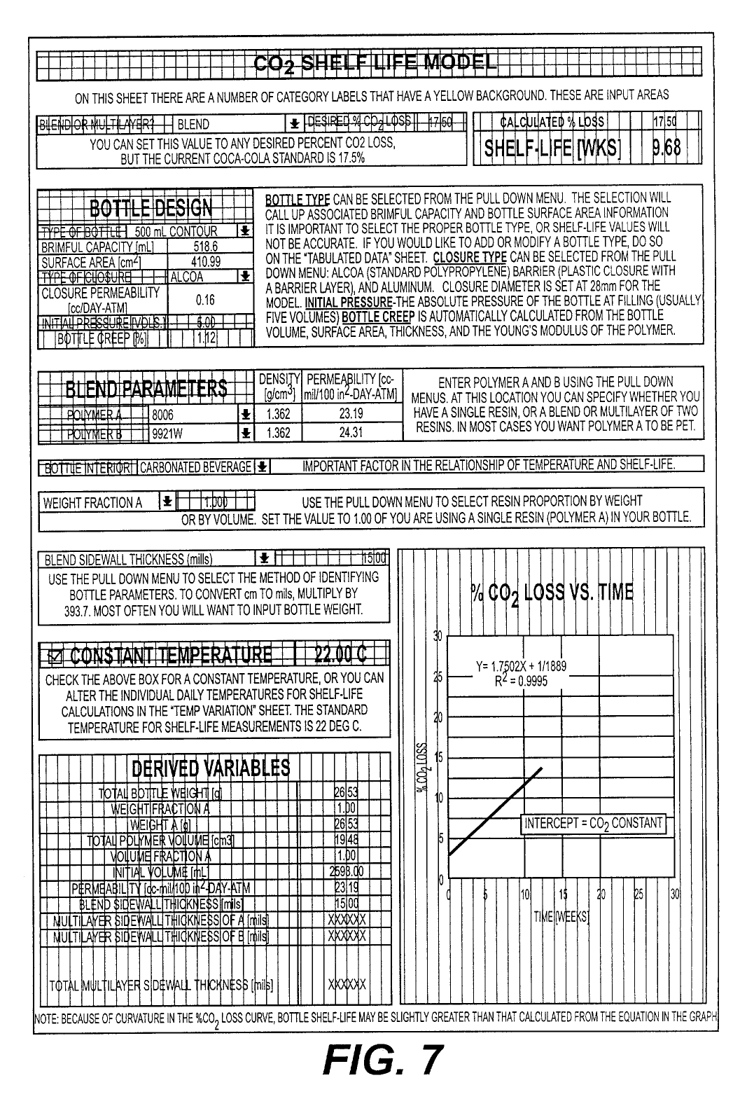

All the phenomena discussed above have been captured in the various shelf-life models developed according to the present invention. These models capture the impact of bottle design, resin selection, bottle sidewall distribution, closure selection, and temperature on shelf-life. Volume expansion, creep, and stress factors are automatically calculated. (Because variations in the stretch blow molding process do not result in variations in permeability, the calculations are greatly simplified.) Through these models, the package designer and the bottle producer can determine how to best optimize container performance. Displays of these models can be found in FIGS. 7 to 11.

These computer models are implemented with a Windows®, operating system with Excel® application software, both of these programs being registered trademarks of Microsoft Corporation. The displays or windows depicted in FIGS. 7 to 11 provide an interactive menu for the computer operator. Input display fields are highlighted and color coded to walk the operator through the input steps required to load the model with the required data parameters. Derived data is displayed as charts or graphs on the respective display screens for quick and easy access by the user.

The first model (FIG. 7) is designed primarily for the package designer. Input fields on the display screen of a typical terminal unit are shown in yellow, and output fields are in red. Pull-down menus are used extensively, and the design or resin selections can be modified readily.

In the example given, a selection has been made for a monolayer bottle. the selection has been made for a blend, but the weight fraction of the first polymer has been set at 1.000, effectively making the bottle entirely from the first listed polymer. the desired % CO₂ loss has been set at 17.5%, and a 500 ml Contour bottle has been selected from the pull-down menu. An Alcoa-type plastic closure has been selected, and 5.00 volumes of CO₂ (absolute pressure) has been entered. Polymer A has been selected to be a Shell 8006 resin. (Most of the copolymer resins available today have essentially the same composition and permeability as Shell 8006. The major exception is the copolymer resins from Eastman, which contains CHDM as a modifier, rather than isophthalic acid.) The bottle interior has been selected to be carbonated beverage, and a choice has been made to specify the bottle sidewall thickness, and all of the bottle sidewall is oriented. (If gram weight had been selected instead, the model would have calculated the sidewall thickness for a completely oriented bottle of that weight.) A fixed temperature of 22 deg C. has been selected, although one could also specify that the daily temperature be set manually. This feature allows calculation of shelf-life where the environment (such as shipping or storage temperature) is expected to vary significantly over time. The program then calculates the bottle expansion and creep, the time to 17.5% CO₂ loss, and the minimum possible weight for that bottle, along with a graphical display of the CO₂ loss with time. In the graph, the equations y=1.7502x+1.1889, R²=0.9995 for the line between 10 days and 49 days is displayed, for comparison to the data that would be generated by the standard FT-IR method.

The second model is directed more toward package authorization and approval, although it is also of use to the package designer. Pull-down menus and color-coding in red and yellow are used here also on the computer monitor. In this model, one cannot specify blends or multilayers. Here, however, you must specify both gram weight and sidewall material distribution.

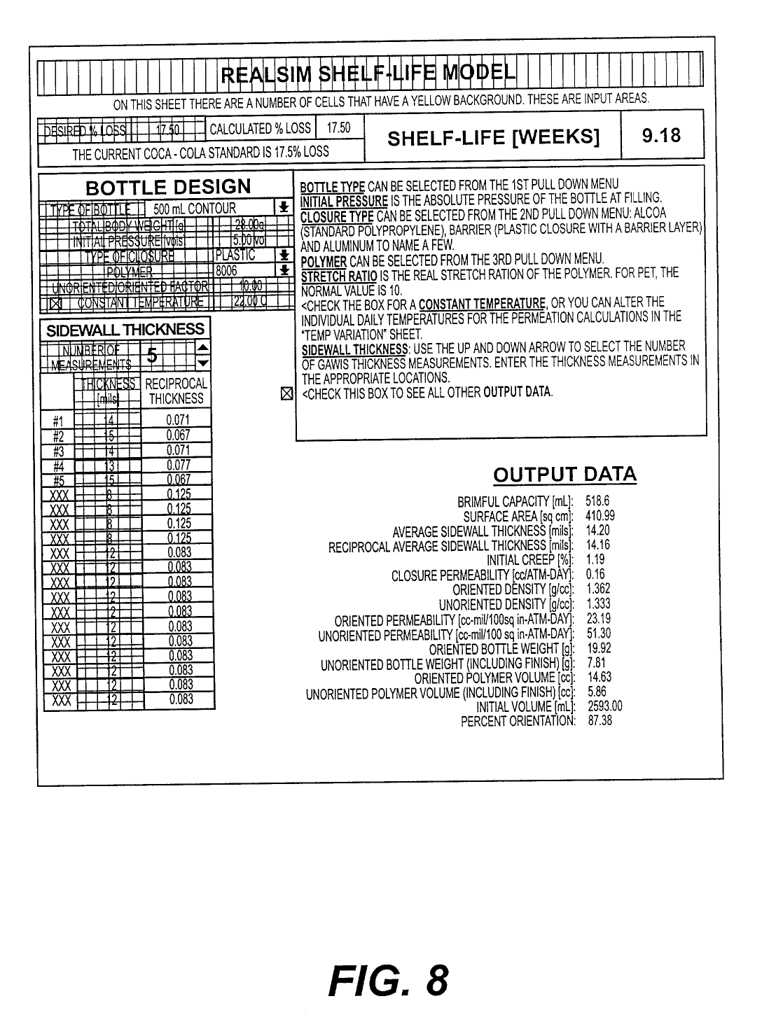

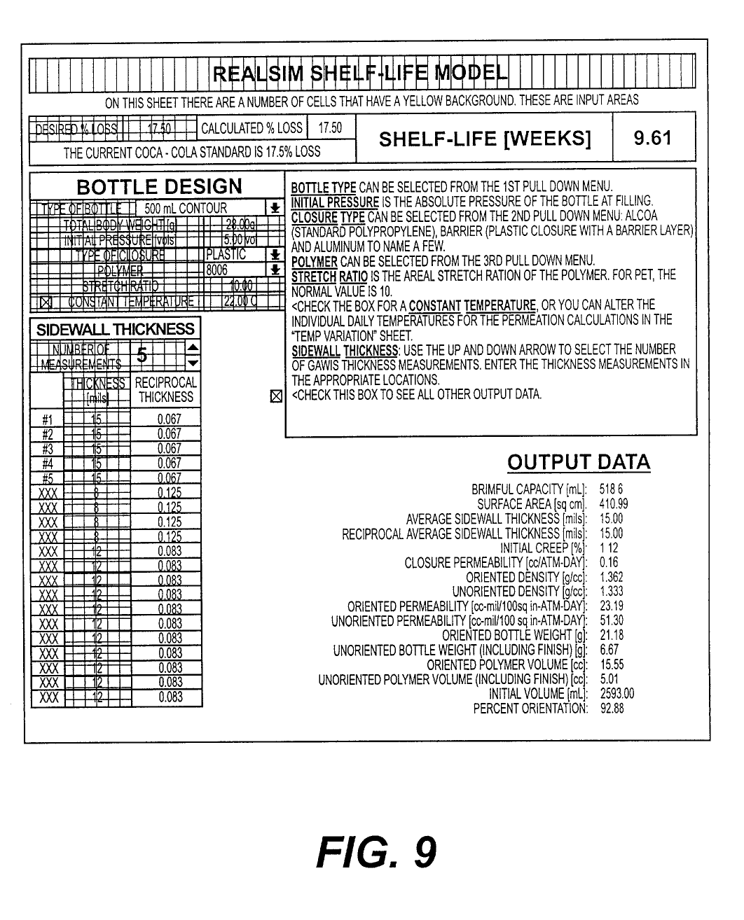

In the two examples given (FIGS. 8 and 9), the same 500 ml Contour bottle has been specified, with a 28.0 gram weight and pressurized to 5.00 volumes of Co₂ (absolute pressure). Once again, an Alcoa-type plastic closure has been selected, and 22 deg C. is the temperature. In FIG. 8, a range of sidewall thicknesses is specified. These represent what might actually be measured in a prototype bottle. (Note: a quirk of Excel is that each time a new sidewall distribution is entered, you need to click the number of measurement arrow(s) to activate the sheet and have the new distribution calculated.) Outputs of the model are the shelf-life (in weeks) and a range of output data. A key output is the percent orientation (last number in the column), which tells you how efficiently the resin has been used. In FIG. 8, the sidewall thickness range from 13 to 15 mils (a mil is 0.0254 mm), the percent orientation is 87.38%, and the shelf-life is 9.18 weeks. In contrast, in FIG. 9 all parameters are the same, except that the sidewall is a uniform 15 mils thick. Now the percent orientation is 92.88%, and the shelf-life has increased to 9.61 weeks. The increase in shelf-life is a result of the better material utilization, which resulted in thicker sidewalls. The thicker sidewalls result in both lower CO₂ loss, and slightly lower creep.

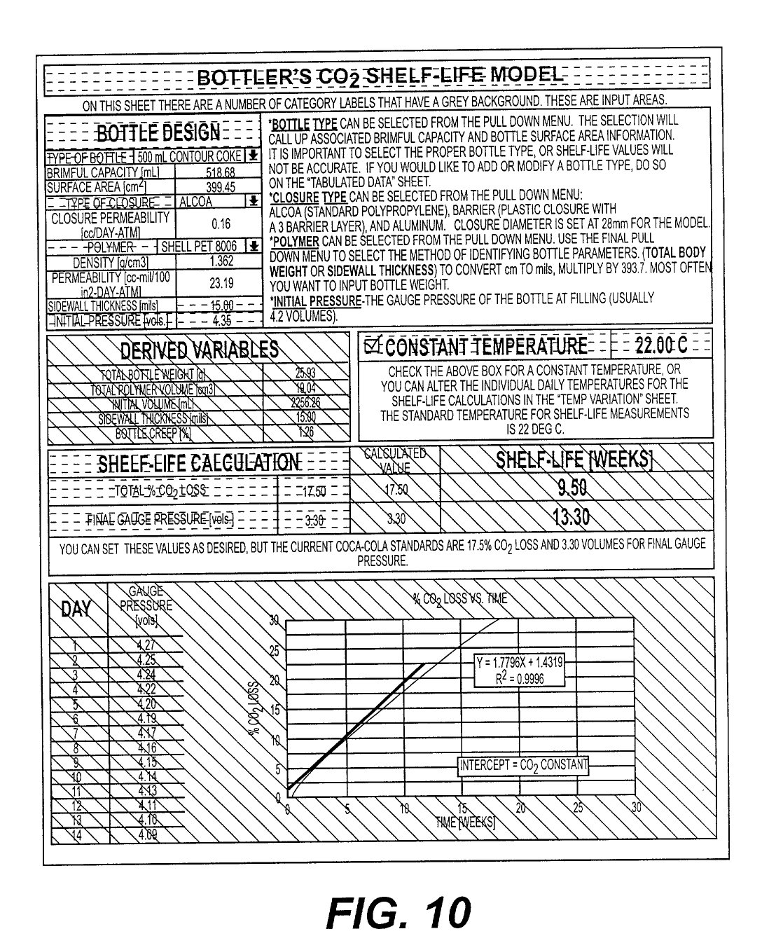

For the bottle user, the invention provides a companion model (see FIG. 10). A key difference between this model and the ones utilized by the bottle designer lie in a subtlety around the definition of shelf-life. The graph of CO₂ loss vs. time at the bottom right corner of the screen is useful in a similar fashion to the graph in the FIG. 7 model.

There are two different criteria that are often applied to establish shelf-life. The first, which is most often used for package approval, is the time required to achieve a 17.5% loss in pressure. The second, which is most often used in quality assurance, is the time necessary to reach 3.3 volumes of CO₂. These two measures are often considered to be equivalent; however, in fact they are equal only under a single set of conditions: that is, when the initial carbonation pressure is 4.0 volumes. This can be seen in the following table (Table 1).

| Initial Pressure (vol.) | Final Pressure (vol.) | % Loss | ΔPressure (vol.) |
|---|---|---|---|
| 5.0 | 3.3 | 34.0 | 1.7 |
| 4.5 | 3.3 | 26.7 | 1.2 |
| 4.0 | 3.3 | 17.5 | 0.7 |
| 3.7 | 3.3 | 10.8 | 0.4 |
| 5.0 | 4.125 | 17.5 | 0.875 |
| 4.5 | 3.713 | 17.5 | 0.788 |

For this reason, this model of FIG. 8 allows calculation of both the time to reach 17.5% loss of CO₂, and the time to reach 3.3 volumes of CO₂. (For convenience, in all the models the loss criteria can be set by the user to any desired value.) This FIG. 8 model also allows the user to set temperatures on a daily basis, so that the impact of bottle storage, rotation, and distribution practices can be evaluated. In the example in FIG. 8, a 500 ml Contour bottle has been filled with carbonated beverage at 22 deg C. at 4.35 volumes instead of 4.0 volumes (here the volumes are gauge, rather than absolute). The impact of the higher fill pressure is to slightly reduce the time required to lose 17.5% of the initial pressure (to 9.5 weeks), but dramatically raise the time required to reach 3.3 volumes (to 13.3 weeks). For convenience the pressure over the first 14 days are also displayed, so that the user can determine the time at which the container will reach 4.0 volumes.

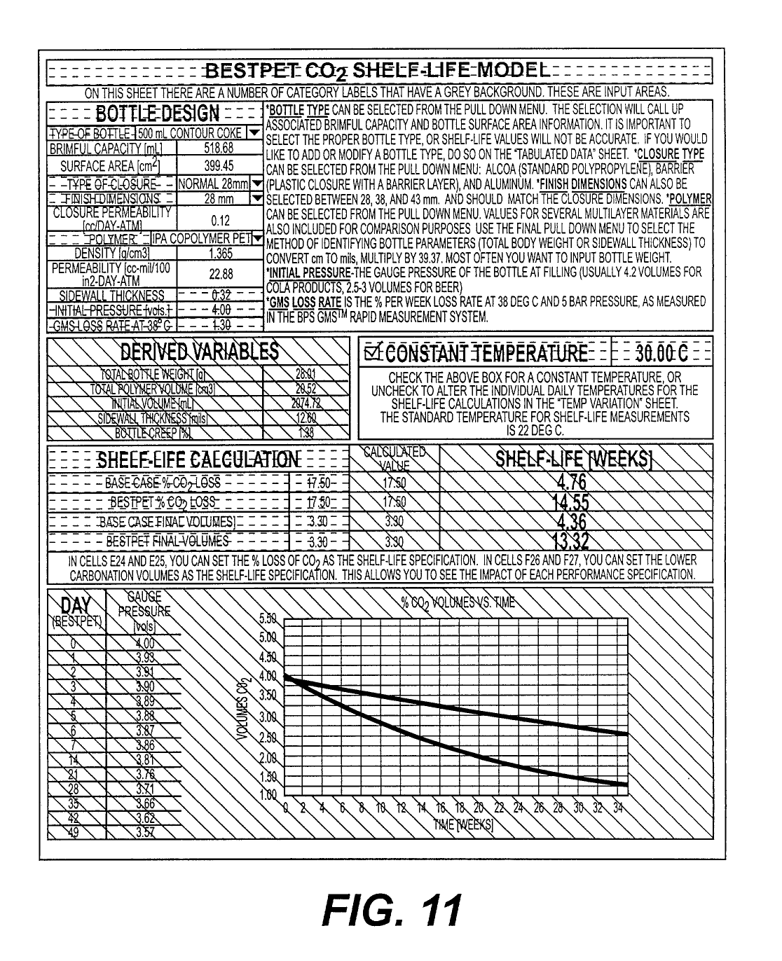

The model depicted on the screen of FIG. 11 is an optimum model for a PET bottle. The refinements therein to FIGS. 7 to 10 are the requirement of the input of bottle finish dimensions and CO₂ gas loss rate. In the BESTPET shelf-life model of FIG. 11, the performance of uncoated bottles is determined by the container volume, surface area, temperature, pressure, and sidewall thickness. The fundamental permeability of the polymer is known, and is included in the model's operating parameters. The impact of volume expansion, creep, thickness, etc are determined by numerical integration of each of their specific contributions. In the case of BESTPET coated bottles, it is not possible to predict the CO₂ loss rate based on these fundamental parameters; therefore, it must be inputted.

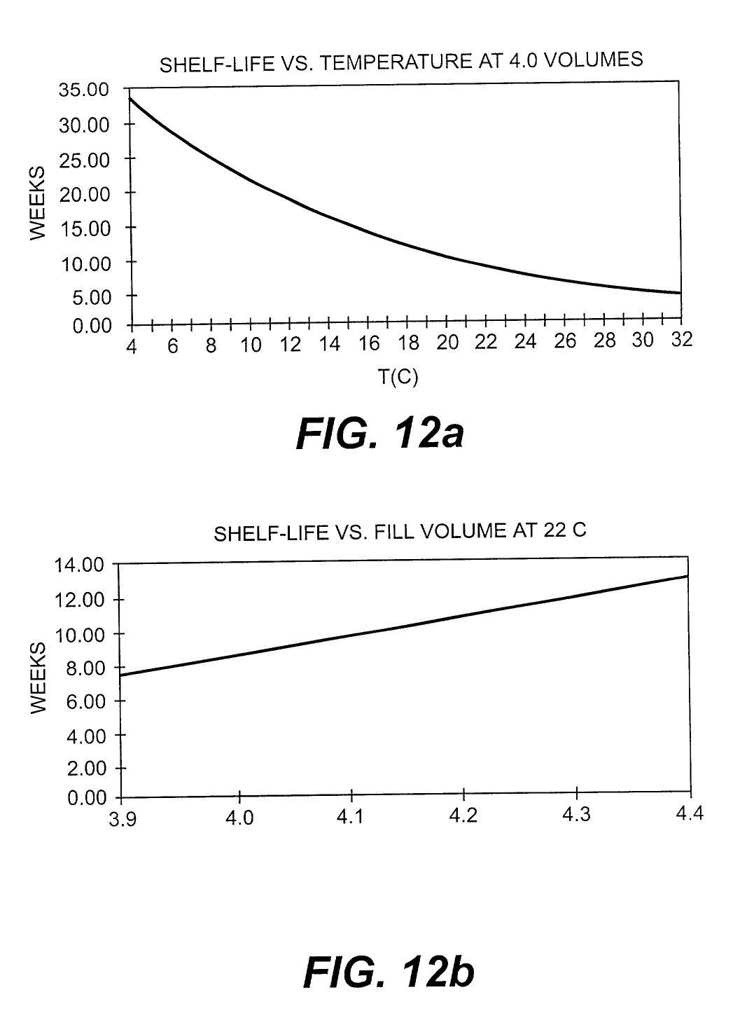

FIGS. 12a and 12b show the dramatic impact of both temperature and initial fill pressure on the time to reach 3.3 volumes of CO₂, with each 0.1 volumes of CO₂ contributing about an additional week to the effective shelf-life of a PET container. Needless to say, there is an enormous opportunity to improve the quality assurance rating of current packages, if low fill pressures can be avoided through quality control of the filling process. Additional benefits to such control will be elimination of over-pressurized containers, which invariably contribute to stress-crack failures.

In the models of the present invention, solubility of CO₂ gas is incorporated into the permeation calculations, and therefore does not need to be treated separately. In fact, to do so would result in a double-counting of the impact of this parameter.

A great deal of the foregoing description has focused on the parameters that affect CO₂ shelf-life, culminating in a description of the computer models in accordance with the invention built to accurately calculate shelf-life. These models incorporate all of the factors that the invention identified as having a meaningful impact on shelf-life.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A computer assisted method for accurately predicting CO₂ shelf-life of plastic containers for carbonated beverages comprising the steps of:
a) establishing a maximum loss value of CO₂ gas from the container at which the carbonated beverage will still be of acceptable quality;
b) selecting the size of plastic container to be designed including,
1) a brimful capacity of the container,
2) a total surface area of the container, and
3) thickness of container sidewalls;
c) selecting a type of closure to be secured on the plastic container;
d) selecting a type of plastic material from which the container is to be fabricated;
e) selecting an initial pressure of the carbonated beverage to be stored in the container; and
f) calculating shelf-life with the computer using data representative of each of the selections made in steps a) to e).

2. The method of claim 1, wherein shelf-life is determined as a function of container pressure loss and volume expansion from equations including:
$$Pressure Loss = \frac{P \times conc . \times time \times total surface area of container}{container volume \times container thickness}$$
wherein, P=permeation of the CO₂ gas through the container
conc.=initial CO₂ pressure in a filled container; and
$$Volume Expansion = \frac{{( 1 + pressure * volume )}^{3}}{{( surface area * tensile modulus * thickness )}^{3}} - 1.$$

3. The method of claim 2 further comprising the steps of:
selecting a value for container volume expansion after an initial volume expansion period known as bottle creep; and
combining bottle creep with the parameters from the selections of steps a) to e) to calculate shelf-life.

4. The method of claim 3 further comprising the steps of:
selecting a stretch ratio of the container for expansion between an initial and final condition; and
combining the stretch ratio with the parameters selected in steps a) to e), and bottle creep, to calculate shelf-life.

5. The method of claim 2 wherein thickness of container sidewalls is calculated from the equation:
$$1 / t h i c k n e s s = \frac{1}{n} \times {{•}_{i = 1}^{n} ( 1 / t h i c k n e s s )}_{i}$$
wherein n=number of incremental areas for making up total surface area.

6. The method of claim 1 further comprising the steps of:
selecting the dimensions of a finish portion of the container to which the closure is secured;
selecting a loss rate of pressure in the container at a predetermined temperature; and
combining the finish dimensions, loss rate and the parameters of steps a) to e) to calculate shelf-life.

7. A computer program embodied on a computer readable medium including a source code for accurately predicting CO₂ shelf-life of plastic containers for carbonated beverages for the program having a plurality of segments comprising:
a) a segment for establishing a maximum loss value of CO₂ gas from the container at which the carbonated beverage will still be of acceptable quality;
b) a segment for selecting the size of plastic container to be designed including,
1) a brimful capacity of the container,
2) a total surface area of the container; and
3) thickness of container sidewalls;
c) a segment for selecting a type of closure to be secured on the plastic container;
d) a segment for selecting a type of plastic material from which the container is to be fabricated;
e) a segment for selecting an initial pressure of the carbonated beverage to be stored in the container; and
f) a segment for calculating shelf-life with the computer using data representative of each of the selections made in segments a) to e).

8. The program and computer readable medium of claim 7, wherein shelf-life is determined as a function of container pressure loss and volume expansion from the equations:
$$Pressure Loss = \frac{P \times conc . \times time \times total surface area of container}{container volume \times container thickness}$$
wherein, P=permeation of the CO₂ gas through the container
conc.=initial CO₂ pressure in a filled container; and
$$Volume Expansion = \frac{{( 1 + pressure * volume )}^{3}}{{( surface area * tensile modulus * thickness )}^{3}} - 1.$$

9. The program and computer readable medium of claim 7 further comprising:
a segment for selecting a value for container volume expansion after an initial volume expansion period known as bottle creep; and
a segment for combining bottle creep with the parameters from the selections of steps a) to e) to calculate shelf-life.

10. The program and computer readable medium of claim 8 further comprising:
a segment for selecting a stretch ratio of the container for expansion between an initial and final condition; and
a segment for combining the stretch ratio with the parameters selected in steps a) to e), and bottle creep, to calculate shelf-life.

11. The program and computer readable medium of claim 6 further comprising:
a segment for selecting the dimensions of a finish portion of the container to which the closure is secured;
a segment for selecting a loss rate of pressure in the container at a predetermined temperature; and
a segment for combining the finish dimensions, loss rate and the parameters of steps a) to e) to calculate shelf-life.

12. The program and computer readable medium of claim 8 wherein thickness of container sidewalls is calculated from the equation:
$$1 / thickness = \frac{1}{n} \times {{□}_{i = 1}}^{n} {( 1 / thickness )}_{i}$$
wherein n=number of incremental areas for making up total surface area.

13. A data signal embodied in a carrier wave for accurately predicting CO₂ shelf-life of plastic containers for carbonated beverages having a plurality of segments comprising:
a) a segment for establishing a maximum loss value of CO₂ gas from the container at which the carbonated beverage will still be of acceptable quality;
b) a segment for selecting the size of plastic container to be designed including,
1) a brimful capacity of the container,
2) a total surface area of the container; and
3) thickness of container sidewalls;
c) a segment for selecting a type of closure to be secured on the plastic container;
d) a segment for selecting a type of plastic material from which the container is to be fabricated;
e) a segment for selecting an initial pressure of the carbonated beverage to be stored in the container; and
f) a segment for calculating shelf-life with the computer using data representative of each of the selections made in segments a) to e).

14. The data signal of claim 5, wherein shelf-life is determined as a function of container pressure loss and volume expansion from the equations including:
$$Pressure Loss = \frac{P \times conc . \times time \times total surface area of container}{container volume \times container thickness}$$
wherein, P=permeation of the CO₂ gas through the container
conc.=initial CO₂ pressure in a filled container; and
$$Volume Expansion = \frac{{( 1 + {pressure}^{*} volume )}^{3}}{{( surface {area}^{*} tensile {modulus}^{*} thickness )}^{3}} - 1.$$
−1.

15. The data signal of claim 14 further comprising:
a segment for selecting a value for container volume expansion after an initial volume expansion period defined hereinafter as bottle creep; and
a segment for combining bottle creep with the parameters from the selections of steps a) to e) to calculate shelf-life.

16. The data signal of claim 15 further comprising:
a segment for selecting a stretch ratio of the container for expansion between an initial and final condition; and
a segment for combining the stretch ratio with the parameters selected in steps a) to e), and bottle creep, to calculate shelf-life.

17. The data signal of claim 13 further comprising:
a segment for selecting the dimensions of a finish portion of the container to which the closure is secured;
a segment for selecting a loss rate of pressure in the container at a predetermined temperature; and
a segment for combining the finish dimensions, loss rate and the parameters of steps a) to e) to calculate shelf-life.

18. The data signal of claim 14 wherein the thickness of the container sidewalls is calculated from the equation:
$$1 / thickness = \frac{1}{n} \times {{□}_{i = 1}}^{n} {( 1 / thickness )}_{i}$$
wherein n=number of incremental areas for making up total surface area.

19. A computer assisted system for accurately predicting CO₂ shelf-life of plastic containers for carbonated beverages comprising:
a) means for establishing a maximum loss value of CO₂ gas from the container at which the carbonated beverage will still be of acceptable quality;
b) means for selecting the size of plastic container to be designed including,
1) a brimful capacity of the container,
2) a total surface area of the container; and
3) thickness of container sidewalls;
c) means for selecting a type of closure to be secured on the plastic container;
d) means for selecting a type of plastic material from which the container is to be fabricated;
e) means for selecting an initial pressure of the carbonated beverage to be stored in the container; and
f) means for calculating shelf-life with the computer using data representative of each of the selections made by means a) to e).

20. The system of claim 19 further comprising one or more data input terminals, each terminal including:
a data input device;
a monitor with a display screen; and
an operating system for providing data input display fields in a window on the display screen, said display fields in combination with said data input device comprising said means a) to e).

21. The system of claim 20, wherein some of said display fields have pull-down menus associated therewith to facilitate selection of predetermined parameters listed in the menus.

22. The system of claim 21, wherein the data input display fields are highlighted to instruct a terminal user as to what selections to make in order to initiate a shelf-life calculation by the computer.

23. The system of claim 22 further comprising:
means for selecting a value for container volume expansion after an initial volume expansion period defined hereinafter as bottle creep; and
means for combining bottle creep with the parameters from the selections of steps a) to e) to calculate shelf-life.

24. The system of claim 23 further comprising:
means for selecting a stretch ratio of the container for expansion between an initial and final condition; and
means for combining the stretch ratio with the parameters selected in steps a) to e), and bottle creep, to calculate shelf-life.

25. The system of claim 22 further comprising:
means for selecting the dimensions of a finish portion of the container to which the closure is secured;
means for selecting a loss rate of pressure in the container at a predetermined temperature; and
means for combining the finish dimensions, loss rate and the parameters of steps a) to e) to calculate shelf-life.
